(19) United States
(12) Patent Application Publication
(10) Pub. No.: US 2021/0285686 A1
(43) Pub. Date: Sep. 16, 2021

(54) AIR CIRCULATOR

(71) Applicant: LG ELECTRONICS INC., Seoul (KR)

(72) Inventors: Joonmin PARK, Seoul (KR); Taeman Yang, Seoul (KR); Junho Min, Seoul (KR); Choonmyun Chung, Seoul (KR)

(21) Appl. No.: 17/142,385

(22) Filed: Jan. 6, 2021

(30) Foreign Application Priority Data
Mar. 10, 2020 (KR) 10-2020-0029852

(51) Int. Cl. F24F 13/08; F24F 1/0029

(52) U.S. Cl. CPC F24F 13/082; F24F 1/0029

(57) ABSTRACT

The present disclosure relates to an air circulator, the air circulator, including: a suction grill part provided with a passage through which air is suctioned; a discharge guide coupled to the suction grill part, and configured to guide discharge of air suctioned through the suction grill part; a motor connected to the discharge guide and configured to supply a rotational power; and a mixed flow fan connected to the motor, rotatably installed in an inner space between the suction grill part and the discharge guide, and configured to discharge air, suctioned through the suction grill part, through the discharge guide upward at a slant.

### CROSS-REFERENCE TO RELATED APPLICATION

This application claims priority to and the benefit of Korean Patent Application No. 10-2020-0029852, filed in Korea on Mar. 10, 2020, the disclosure of which is incorporated herein by reference in its entirety.

### TECHNICAL FIELD

Disclosed herein is an air circulator, and, more particularly, an air circulator to which a mixed flow fan and a guide vane are applied.

### BACKGROUND

Air circulators are devices designed to circulate air to provide a pleasant environment, and are also referred to as circulators. Air circulators are identical with wing-type fans in terms of the theory that wings attached to a motor produce air. However, the circulators are different from the fans in that the circulators enable air to move linearly to a far area and uniformize air in an indoor space. Additionally, air circulators can move cold air up and move hot air down, and can reduce electricity consumption when they operate along with an air conditioner.

Further, when an additional air circulator is installed in a module of an air cleaner, the air circulator can be rotated in a desired direction to readily distribute purified air.

An air circulator includes a fan motor, and a blowing fan that is coupled to a rotation shaft of the fan motor and is configured to suction air while rotating as a result of driving of the fan motor and to discharge air. The blowing fan is classified as an axial flow fan, a centrifugal fan and the like, based on a direction of movement of air.

The axial flow fan has a structure where air is suctioned in a direction (hereinafter “shaft direction”) of the rotation shaft of the fan motor and is discharged in the shaft direction. The centrifugal fan has a structure where air is suctioned in the shaft direction and discharged in a radial direction.

The axial flow fan has been used as a blowing fan of an air circulator of the related art. However, in the axial flow fan, a reduction in a surface area of a discharge flow channel results in a significant reduction in an amount of air, and, while air passes through a guide vane, loss of energy of an air flow can occur.

An air cleaning apparatus is disclosed as a related art in Korean Patent No. 10-1955877 (registered on Mar. 3, 2019).

### SUMMARY

The present disclosure is directed to an air circulator using a mixed flow fan that may generate a larger amount of air than an axial flow fan on a limited surface area of a flow channel to smoothly circulate air.

The present disclosure is also directed to an air circulator that may include a guide vane capable of reducing loss of flow energy to allow air current to move a predetermined distance or greater.

Aspects are not limited to the above ones, and other aspects and advantages that have not been mentioned can be clearly understood from the following description and can be more clearly understood from the embodiments set forth herein. Further, the aspects and advantages can be realized via means and combinations thereof in the appended claims.

An air circulator according to the present disclosure may include a suction grill part provided with a passage through which air is suctioned, a discharge guide coupled to the suction grill part and configured to guide discharge of air suctioned through the suction grill part, a motor connected to the discharge guide and configured to supply a rotational power, and a mixed flow fan connected to the motor, rotatably installed in an inner space between the suction grill part and the discharge guide and configured to discharge air, suctioned through the suction grill part, through the discharge guide upward at a slant.

The air circulator may further include a front panel mounted onto a front surface of the discharge guide.

The front panel may have a circular plate shape, and may have a guide vane configured to guide discharge of air along an outer circumference of the front panel.

The suction grill part may include a suction grill facing the inner space and forming a passage through which air moves, and a suction body installed along an outer circumference of the suction grill and extended toward an edge of the discharge guide.

The discharge guide may include a core member which is configured to support the motor and movement of which is constraint, a guide vane installed along an upper circumference of the core member and configured to guide discharge of air, and a discharge body installed along an outer circumference of the guide vane and extended toward the suction body.

Additionally, a front panel may be installed at a front of the core member, and the motor may be installed between the core member and the front panel.

The mixed flow fan may include a connection body disposed between the core member and the suction grill, connected to an output shaft of the motor and configured to rotate along with the output shaft, an inner body extended from the connection body, installed in a way that encircles the core member and spaced from the core member, an outer body installed outside the connection body in a ring shape and spaced from the suction body, and a wing member configured to connect the inner body and the outer body.

The inner body and the outer body may be installed at a slant with respect to the suction grill.

The inner body may be installed in a concave form toward a direction where the core member is installed.

The wing member may be a rectangular plate, and a plurality of wing members may be installed along an outer circumference of the inner body and installed upward at a slant.

Further, inner diameters of the inner body and the outer body gradually increase toward the discharge guide.

The outer body may further include an inlet projection protruding from the outer body to a rear where the suction grill part is disposed, and forming a projection having a ring shape.

The suction grill part may further include a bell mouth protruding from the suction body toward the mixed flow fan along an edge of the suction grill, and extending toward an inside of the inlet projection.

A gap between the bell mouth and the inlet projection may be less than a gap between the outer body and the suction body.

The connection body may include a hub plate having a circular plate shape, a shaft coupler disposed at a center of the hub plate in a radial direction thereof and connected to the motor, and a first reinforcement projection extending from the shaft coupler radially.

An air circulator according to the present disclosure may use a mixed flow fan to circulate air such that the mixed flow fan generates a larger amount of air than an axial flow fan to smoothly circulate air.

The air circulator may reduce loss of energy of an air flow discharged along a guide vane and move air current to move a predetermined distance or greater, thereby saving energy.

Specific effects are described together with the above-described effects in the section of Detailed Description.

### BRIEF DESCRIPTION OF DRAWINGS

The accompanying drawings constitute a part of this specification, illustrate one or more embodiments of the present disclosure, and together with the specification, explain the present disclosure, wherein:

FIG. 1 is an exploded perspective view showing an example air circulator;

FIG. 2 is a plane view showing an example air circulator;

FIG. 3 is a lateral cross-sectional view showing an example air circulator;

FIG. 4 is a side view showing an example mixed flow fan;

FIG. 5 is a perspective view showing an example guide vane; and

FIG. 6 is a table showing a result of interpretation of a change in air amounts based on a size of an example front panel.

### DETAILED DESCRIPTION

The above-described aspects, features and advantages are specifically described hereunder with reference to the accompanying drawings such that one having ordinary skill in the art to which the present disclosure pertains can easily implement the technical spirit in the disclosure. In the disclosure, detailed description of known technologies in relation to the disclosure is omitted if it is deemed to make the gist of the disclosure unnecessarily vague. Below, preferred embodiments according to the disclosure are specifically described with reference to the attached drawings. Throughout the disclosure, identical reference numerals can denote identical or similar components.

It should be understood that the terms “first”, “second” and the like are used herein only to distinguish one component from another component. Thus, the components should not be limited by the terms. Certainly, a first component can be a second component unless stated to the contrary.

When one component is described as being “in an upper portion (or a lower portion)” of another component, or “on (or under)” another component, one component may be placed on the upper surface (or under the lower surface) of another component, and an additional component may be interposed between another component and one component on (or under) another component.

When one component is described as being “connected”, “coupled”, or “connected” to another component, one component can be directly connected, coupled or connected to another component; however, it is also to be understood that an additional component can be “interposed” between the two components, or the two components can be “connected”, “coupled”, or “connected” through an additional component.

Throughout the disclosure, each component can be provided as a single one or a plurality of ones, unless explicitly stated to the contrary.

The singular forms “a”, “an” and “the” are intended to include the plural forms as well, unless explicitly indicated otherwise. It should be further understood that the terms “comprise” or “have,” set forth herein, are not interpreted as necessarily including all the stated components or steps but can be interpreted as including some of the stated components or steps or can be interpreted as further including additional components or steps.

Throughout the disclosure, the terms “A and/or B” as used herein can denote A, B or A and B, and the terms “C to D” can denote C or greater and D or less, unless stated to the contrary.

Below, an air circulator 1 according to one embodiment is described.

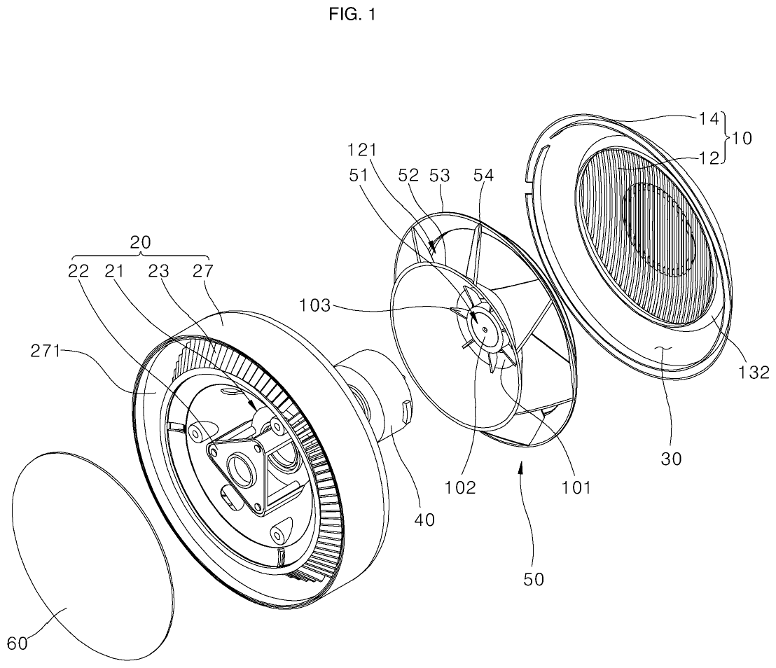

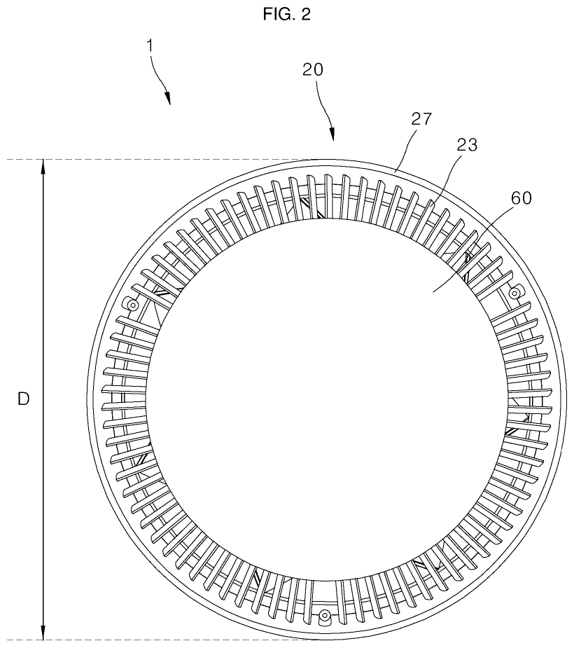

FIG. 1 is an exploded perspective view showing an example air circulator 1, and FIG. 2 is a plane view showing an example air circulator 1.

The air circulator 1, as shown in FIGS. 1 and 2, may include one or more of a suction grill part 10, a discharge guide 20, a motor 40, a mixed flow fan 50 and a front panel 60.The air circulator 1 may be installed in an air conditioner in a row, and may be installed in an air purifier such as an air conditioner in a row. Accordingly, the air circulator 1 may be installed in many different ways.

The suction grill part 10 may be implemented in many different forms within the scope of the technology by which the suction grill part 10 is provided with a passage through which air is suctioned. The suction grill part 10 according to one embodiment may include a suction grill 12 and a suction body 14.

The suction grill 12 may be implemented in many different forms within the scope of the technology by which the suction grill 12 faces an inner space 30 and forms a passage through which air moves. Edges of the discharge guide 20 and the suction grill part 10 may be coupled, and the inner space 30 for installing the mixed flow fan 50 may be formed between the discharge guide 20 and the suction grill part 10.

The suction grill 12 may be provided with a plurality of vents. For the suction grill 12 according to one embodiment, vents having a straight line shape may be installed on a circular plate in a row.

The suction body 14 may be installed along an outer circumference of the suction grill 12, and may be implemented in many different forms within the scope of the technology by which the suction body 14 extends toward the edge of the discharge guide 20. The suction body 14 according to one embodiment may extend from the edge of the suction grill 12 toward the edge of the discharge guide 20 at a slant.

The suction body 14 may extend in a concave form toward the front while facing an outer body 53 of the mixed flow fan 50, and may be provided with the suction grill 12 for movement of air at a center of the suction body 14.

The suction grill part 10 may further include a bell mouth 132 protruding from the suction body 14 toward the mixed flow fan 50 along the edge of the suction grill 12, and extending toward an inside of an inlet projection 121.

The bell mouth 132 may protrude from the suction body 14 toward the mixed flow fan 50 along the edge of the suction grill 12, and may be installed in a ring shape. The bell mouth 132 may have a concavely-shaped longitudinal cross section encircling an end of the inlet projection 121 provided at the outer body 53, and may extend along a circumferential direction.

The bell mouth 132 may be formed in a way that encircles an outer circumferential surface of the suction grill 12 at the center of the suction body 14. The bell mouth 132 may have a projection shape that extends toward the inside the inlet projection 121, and may guide air to an inlet of the mixed flow fan 50 through the suction grill 12. Additionally, a gap between the bell mouth 132 and the inlet projection 121 is less than a gap between the outer body 53 and the suction body 14. Accordingly, air moving along the outer body 53 and the suction body 14 may be prevented from coming out between the bell mouth 132 and the inlet projection 121, thereby blocking the air from spinning. Since the mixed flow fan 50 prevents air from spinning, air blow efficiency of the mixed flow fan 50 may improve.

The bell mouth 132 may be at least partially inserted into the outer body 53 in a radial direction. The bell mouth 132 ma guide a suction flow at an inlet of the mixed flow fan 50 and help the mixed flow fan 50 to improve suction and discharge performance.

The discharge guide 20 may be coupled to the suction grill part 10, and may be implemented in many different forms within the scope of the technology by which discharge of air suctioned through the suction grill part 10 is guided. The discharge guide 20 according to one embodiment may include a core member 21, a motor bracket 22 and a discharge body 27.

The core member 21 may be implemented in many different forms within the scope of the technology by which movement of the core member 21 is constrained while the core member 21 supports the motor 40. The core member 21 according to one embodiment may be disposed at a central portion of the discharge guide 20, and may be provided with a front panel at the front (the left in FIG. 1) of the core member 21.

The core member 21 may have a shape that is concave toward the front, and a motor 40 may be installed between the core member 21 and the front panel 60. The core member 21 may be provided with a motor bracket 22 that fixes the motor 40. The motor bracket 22 may protrude from a body of the core member 21 toward the front, and may be installed in a way that encircles the front of the motor 40.

The guide vane 23 may be installed along an upper circumference of the core member 21, and may be implemented in many different forms within the scope of the technology by which the guide vane 23 guides discharge of air. The guide vane 23 according to one embodiment may be disposed between the core member 21 and the discharge body 27, and a plurality of guide vanes 23 may be installed along an outer circumference of the core member 21 at a slant. For the guide vane 23, a plate bent along/in a curve surface shape may be installed radially around the core member 21.

Additionally, one side of the guide vane 23 may be connected to an edge of the core member 21, and the other side of the guide vane 23 may be connected to a lower side of the discharge body 27 extending in a strap shape along the circumferential direction. Accordingly, the guide vane 23 may be installed at a slant in a diagonal direction and installed to face a wing member 54.

Additionally, since the discharge body 27 may be disposed outside the guide vane 23, a foreign substance may be prevented from coming into the guide vane 23. Further, since the guide vane 23 is installed at a slant, a surface area for discharging air may increase, and more air may be discharged out of the guide vane 23. Furthermore, since the discharge body 27 having a cylindrical shape may be disposed outside the guide vane 23, air discharged from the guide vane 23 may make a linear movement in one direction while contacting the discharge body 27, thereby improving the linearity of the discharged air and enabling the discharged air to move far away.

The guide vane 23 disposed between the core member 21 and the discharge body 27 may be installed at a slant while facing a wing member 54. Accordingly, air moving to the guide vane 23 through the wing member 43 may pass through the guide vane 23 while forming an angle of 90 degrees with the guide vane 23, thereby reducing friction of air against the guide vane 23. Thus, friction resistance of air discharged from the mixed flow fan 50 and passing through the guide vane 23 may be reduced.

The discharge body 27 connected to an outer end of the guide vane 23 may be provided with a guide curved surface 271 having a concave shape such that air discharged from the guide vane 23 has linearity. The guide curved surface 271 may protrude toward the inside of the discharge body 27, and have a diameter which gradually increases from a portion connected to the guide vane 23 toward the front of the discharge body 27 through which air is discharged. Accordingly, air discharged at a slant through the mixed flow fan 50 and the guide vane 23 may be guided toward a front of the air circulator 1 when discharged along the guide curved surface 271, thereby minimizing flow resistance of the air and ensuring linearity of the air.

With the guide vane 23 and the guide curved surface 271, loss of flow energy of discharged air may be reduced and performance of discharge of air may be improved such that the air current reaches a predetermined distance or longer.

The discharge body 27 may be installed along an outer circumference of the guide vane 23, and may be implemented in many different forms within the scope of the technology by which the discharge body 27 extends toward the suction body 14. The discharge body 27 according to one embodiment may be connected to the suction body 14 and form a side of the air circulator 1. An inner space 30 may be formed between the discharge guide 20 and a suction grill part 10.

Since the discharge guide 20 is provided with the guide vane 23 installed at a slant, friction, which is caused by air discharged from the mixed flow fan 50 when the air contacts the guide vane 23, may be minimized, and the mixed flow fan 50 may reduce loss of energy of the air and enable air current to move farther away than an axial flow fan despite a relative small amount of air.

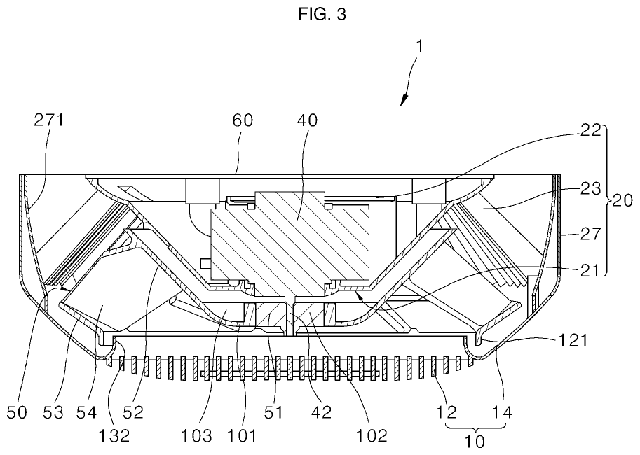

FIG. 3 is a lateral cross-sectional view showing an example air circulator

The motor 40, as shown in FIG. 3, may be implemented in many different forms within the scope of the technology by which the motor 40 is connected to the discharge guide 20 and supplies a rotational power to rotate the mixed flow fan 50. The motor 40 according to one embodiment may be fixed to the core member 21. A body of the motor 40 may be mounted onto the motor bracket 22 installed at a front of the core member 21, and an output shaft 42 extended from the motor 40 may be connected to the mixed flow fan 50 in the inner space 30.

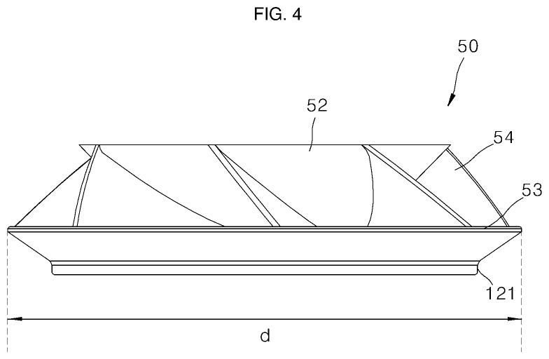

FIG. 4 is a side view showing an example mixed flow fan 50.

As shown in FIG. 1 and FIG. 3 and FIG. 4, the air circulator 1 according to one embodiment uses the mixed flow fan 50 instead of an axial flow fan to discharge as much air as possible under the conditions of limited surface area of a flow channel. To minimize loss of energy of an air flow, air having passed through the mixed flow fan 50 may pass through the guide vane and be discharged out of the discharge guide 20.

The mixed flow fan 50 according to one embodiment may circulate air current while minimizing a reduction in air amounts on a limited surface area of a discharge flow channel. Since the air circulator 1 according to one embodiment uses the mixed flow fan 50, the air circulator 1 may ensure relatively little loss of air amounts even when a surface area of a discharge flow channel is reduced. Additionally, the mixed flow fan 50 may help to generate a larger amount of air than an axial flow fan on a limited surface area of a flow channel, thereby enabling a smooth circulation of air.

The mixed flow fan 50 may be connected to the motor 40 and rotatably installed in the inner space 30 between the suction grill part 10 and the discharge guide 20. The mixed flow fan 50 may be implemented in many different forms within the scope of the technology by which air suctioned through the suction grill part 10 is discharged upward through the discharge guide 20 at a slant. The mixed flow fan 50 according to one embodiment may include a connection body 51, an inner body 52, an outer body 53 and a wing member 54.

The connection body 51 may be disposed between the core member 21 and the suction grille 12, connected to the output shaft 42 of the motor 40 and implemented in many different forms within the scope of the technology by which the connection body 51 rotates together with the output shaft 42. The connection body 51 according to one embodiment may have a cylindrical shape, may be connected to the output shaft 42 and may rotate together with the output shaft 42. Additionally, the connection body 51 may be disposed at a central portion where a gap between the core member 21 and the suction grille 12 is narrowest.

The connection body 51 may be disposed at a center of the mixed flow fan 50 and may be implemented in many different forms within the scope of the technology by which the connection body 51 is supplied with an external driving force to rotate.

The connection body 51 may be disposed at the center of the mixed flow fan 50 in a radial direction thereof, and may rotate together with the output shaft 42 extended from the motor 40. The connection body 51 according to one embodiment may include a hub plate 101, a shaft coupler 102 and a first reinforcement projection 103.

The hub plate 101 may be formed into a circular plate in parallel with the front panel 60. The hub plate 101 may be provided with a shaft coupler 102. The shaft coupler 102 may be disposed at a center of the hub plate 101 in a radial direction thereof. The shaft coupler 102 may be formed to protrude from the hub plate 101 toward the motor 40.

The shaft coupler 102 may be coupled to an end of the output shaft 42 configured to deliver a rotational power in a shaft direction thereof. For example, the shaft coupler 102 may be coupled to the output shaft 42 in a way that the output shaft 42 is fitted into the shaft coupler 102.

The first reinforcement projection 103 may be installed at predetermined intervals along an outer circumference of the shaft coupler 102. The first reinforcement projection 103 may be radially installed around the shaft coupler 102, and the first reinforcement projection having a plate shape may be installed outside the shaft coupler 102. Additionally, the first reinforcement projection may extend radially from the shaft coupler 102.

Accordingly, since stress concentrated on the shaft coupler 102 may be dispersed through the first reinforcement projection 103, structural rigidity of the shaft coupler 102 may be reinforced.

The inner body 52 may be installed in a way that extends from the connection body 51 and encircles the core member 21, and may be implemented in many different forms within the scope of the technology by which the inner body 52 is spaced apart from the core member 21. The inner body 52 according to one embodiment may be installed in a concave form that encircles an inside of the core member 21. That is, the inner body 52 may be installed in a concave form toward a direction in which the core member 21 is installed, thereby ensuring a maximum size of a space, where the wing member 54 is installed, between the inner body 52 and the outer body 53 and an increase in an amount of discharged air.

Additionally, since the inner body 52 does not contact the core member 21, friction caused by contact between the inner body 52 and the core member 21 may be prevented when the inner body 52 rotates.

The inner body 52 may protrude from an edge of the hub plate 101 toward the guide vane 23. The inner body 52 may form an inclined surface that inclines outward radially as the inner body 52 become farther from the hub plate 101. An inner diameter of the inner body 52 may gradually increase from the connection body toward the front panel.

For example, a shape, where the hub plate 101 and the inner body 52 are connected, may be a truncated cone, which has a hollow hole therein and one side of which is open. The inner body 52 may have a funnel shape the front of which faces the front panel and is open, and the rear of which is closed by the hub plate 101.

The outer body 53 may be installed in a ring shape outside the connection body 51, and may be implemented in many different forms within the scope of the technology by which the outer body 53 is spaced from the suction body 14. The outer body 53 according to one embodiment may have a plate shape and may be installed at a slant along a circumference.

The inner body 52 and the outer body 53 may be installed at a slant with respect to the suction grill 12. Additionally, the inner body 52 and the outer body 53 may be installed in parallel with each other or installed to face each other.

The outer body 53 may be installed along an outer circumference of the inner body 52, and may be connected to the inner body 52 by the wing member 54. An outer diameter of the inner body 52 and an inner diameter of the outer body 53 may gradually decrease from the front toward the rear. The inner diameters of the inner body 52 and the outer body 53 may gradually increase toward the discharge guide 20.

With respect to the mixed flow fan 50, a direction in which the front panel 60 is disposed is referred to as the front, and a direction in which the suction grill part 10 is disposed is referred to as the rear.

The outer body 53 may be spaced a predetermined distance apart from the inner body 52 radially, and may be disposed outside the inner body 52 in a radial direction thereof. Additionally, the outer body 53 may be spaced from the inner body 52 by a distance corresponding to a length of the wing member 54 in a radial direction thereof. Each wing member 54 may connect between the inner body 52 and the outer body 53.

The outer body 53 may form an inclined surface approximately in parallel with the inner body 52. In the embodiment, the inner body 52 and the outer body 53 are disposed such that a gap between the inner body 52 and the outer body 53 may gradually increase toward a front of the outer body 53, for example.

An inlet projection 121 at a rear of the outer body 53 may be a projection having a ring shape, and may extend from the funnel-shaped outer body 53 to the rear where the suction grill part 10 is disposed. The inlet projection 121 may be disposed inside a bell mouth 132 installed in the suction grill part 10. Accordingly, air moving between the outer body 53 and the suction body 14 along the outside of the outer body 53 may prevent air suctioned into an inlet of the mixed flow fan 50 from making a spinning movement.

The wing member 54 may connect the inner body 52 and the outer body 53, and may be implemented in many different forms within the scope of the technology by which the wing member 54 discharges air suctioned into the inner space 30 to the guide vane 23 through the suction grill part 10. The wing member 54 according to one embodiment may have a rectangular plate shape, and a plurality of wing members 54 may be installed along the outer circumference of the inner body 52. Further, the wing member 54 may be installed to incline upward (with respect to FIG. 3), to maximize a surface area in contact with air.

A plurality of wing members 54 may be provided and spaced at regular intervals along an outer circumferential surface of the connection body 51. The wing member 54 may protrude outward from the inner body 52 and extend in a spiral shape. Additionally, the plurality of wing members 54 may be spaced a predetermined distance apart from each other along a circumferential direction of the inner body 52.

The wing member 54 according to one embodiment may protrude outward from the inner body 52 along a centrifugal direction spirally extending from the center of the shaft coupler 102. Additionally, under the assumption that a direction from the outside of the shaft coupler 102 toward the shaft coupler 102 is a radial direction, an inside of the wing member 54 in the radial direction thereof may be connected to the inner body 52, and an outside of the wing member 54 in the radial direction thereof may be connected to the outer body 53.

The inner body 52, which is a portion directly connected to the wing member 54, may be a portion directly contacting air passing through the wing member 54. The inner body 52 may closely relate to a flow path of air passing through the air circulator 1.

The front panel 60 may be implemented in many different forms within the scope of the technology by which the front panel 60 is mounted onto a front surface of the discharge guide 20 and protects the motor 40. The front panel 60 according to one embodiment may have a circular plate shape, and may be provided with the guide vane 23 that guides discharge of air along an outer circumference of the front panel 60.

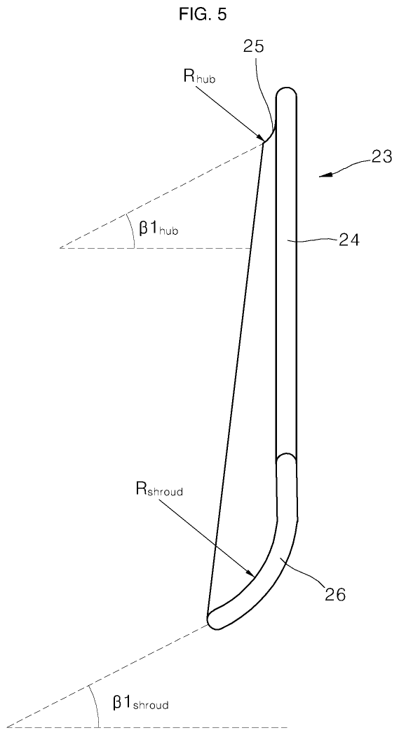

FIG. 5 is a perspective view showing an example guide vane 23.

The guide vane 23, as shown in FIG. 5, may include a vane body 24 forming a curved surface where a plate having a trapezium shape is convexly bent as a whole.

A widthwise length of a first end 25 on one end of the vane body 24 may be less than a widthwise length of a second end 26 on the other end of the vane body 24.

A curvature radius of the first end 25 is defined as a first curvature radius (Rhub), and a curvature radius of the second end 26 is defined as a second curvature radius (Rshroud). An angle formed by the first end 25 and a horizontal virtual line is defined as a first angle (β1hub), and an angle formed by the second end 26 and the horizontal virtual line is defined as a second angle (β1shroud). Herein, a range of the first angle (β1hub) according to one embodiment may be expressed as formula 1.

β1_{hub}:50°˜60° Formula 1:

A value as a result of division of the first curvature radius (Rhub) by a diameter (d) of the mixed flow fan may be expressed as formula 2.

R_{hub}/d:0.0.35˜0.055 Formula 2:

A range of the second angle (β1shroud) according to one embodiment may be expressed as formula 3.

β1_{shroud}: 25°˜35° Formula 3:

A value as a result of division of the second curvature radius (Rshroud) by the diameter (d) of the mixed flow fan may be expressed as formula 4.

R_{shroud/d:} 0.03˜0.05 Formula 4:

The number of the guide vanes 23 according to one embodiment may be set to 65 to 80. When the number of the guide vanes 23 is less than 65, a space among the guide vanes 23 may be wide enough for a finger and the like to be inserted into the inner space 30. Accordingly, the finger may contact the mixed flow fan 50, causing a safety accident.

When the number of the guide vanes 23 is greater than 80, a space among the guide vanes 23 is too narrow. Accordingly, discharge resistance of air may increase, causing a reduction in a discharge amount.

With the guide vane 23 designed as described above, loss of energy of discharged air may be reduced, and air current may move farther away than usual. Additionally, since the guide vane 23 serves as a grill for improving safety of a user, the user's finger or other foreign substances may be prevented from contacting a rotating mixed flow fan 50.

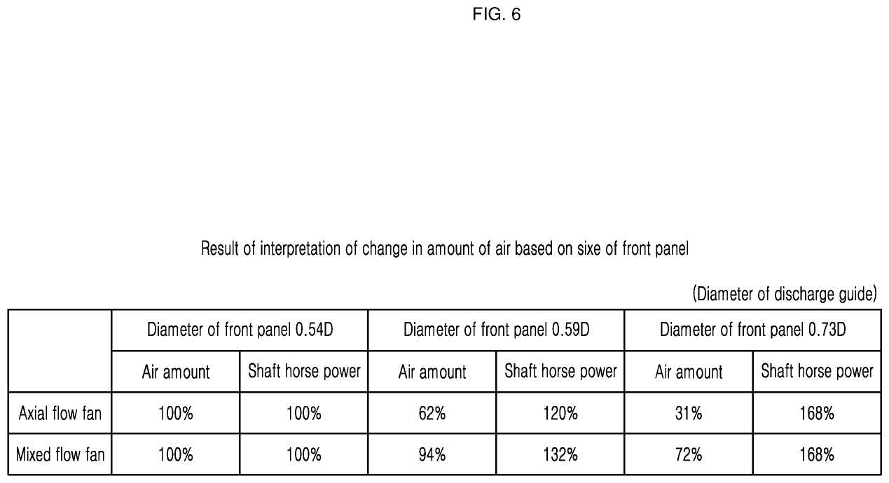

FIG. 6 is a table showing a result of interpretation of a change in air amounts based on a size of an example front panel 60.

FIG. 6 shows that, under the assumption that a diameter of the discharge guide is set to D, air amounts and shaft horse power of an axial flow fan and the mixed flow fan 50 when a diameter of the front panel 60 is 0.54, 0.59 and 0.73 times greater than the diameter (D) of the discharge guide.

An increase in the size of the front panel 60 may result in a reduction in air amounts in all cases. When the mixed flow fan 50 instead of an axial flow fan is applied, the mixed flow fan 50 may help ensure a larger amount of air than the axial flow fan even in a relatively small discharge outlet.

Below, an operation state of the air circulator 1 according to one embodiment is described with reference to the accompanying drawings.

When the motor 40 operates, the connection body 51 connected to the output shaft 42 of the motor 40 may rotate. The wing member 54 connecting the inner body 52 and the outer body 53 may rotate, while the inner body 52 and the outer body 53 connected to the connection body 51 rotate.

As the wing member 54 rotates, air may be suctioned through the suction grill 12 disposed in the shaft direction and may be discharged upward (with respect to FIG. 3) at a slant. The air discharged through the wing member 54 may be discharged out of the guide vane 23 and then may be moved forward (the left with respect to FIG. 1) by the discharge body 27 while making a linear movement.

According to the disclosure, the mixed flow fan 50 may be used to circulate air, as described above. Accordingly, the mixed flow fan 50 may produce a larger amount of air than an axial flow fan to facilitate air circulation. Further, the mixed flow fan 50 may help reduce loss of flow energy of air discharged along the guide vane 23, thereby enabling air current to move a predetermined distance or greater and ensuring energy savings.

The embodiments are described above with reference to a number of illustrative embodiments thereof. However, the present disclosure is not intended to limit the embodiments and drawings set forth herein, and numerous other modifications and embodiments can be devised by one skilled in the art without departing from the technical spirit of the disclosure. Further, the effects and predictable effects based on the configurations in the disclosure are to be included within the range of the disclosure though not explicitly described in the description of the embodiments.

### DESCRIPTION OF SYMBOLS

1: Air circulator

10: Suction grill part

12: Suction grill

14: Suction body

20: Discharge guide

21: Core member

22: Motor bracket

23: Guide vane

24: Vane body

25: First end

26: Second end

27: Discharge body

30: Inner space

40: Motor

42: Output shaft

50: Mixed flow fan

51: Connection body

52: Inner body

53: Outer body

54: Wing member

60: Front panel

d: Diameter of mixed flow fan

D: Diameter of discharge guide

Rhub: First curvature radius

Rshroud: Second curvature radius

β1 hub: First angle

βshroud: Second angle

1. An air circulator, comprising:
a suction grill part provided with a passage through which air is suctioned;
a discharge guide coupled to the suction grill part, and configured to guide discharge of air suctioned through the suction grill part;
a motor connected to the discharge guide and configured to supply a rotational power; and
a mixed flow fan connected to the motor, rotatably installed in an inner space between the suction grill part and the discharge guide, and configured to discharge air, suctioned through the suction grill part, through the discharge guide upward at a slant.

2. The air circulator of claim 1, further comprising:
a front panel mounted onto a front surface of the discharge guide.

3. The air circulator of claim 2, wherein the front panel has a circular plate shape, and a guide vane configured to guide discharge of air along an outer circumference of the front panel.

4. The air circulator of claim 1, the suction grill part, comprising:
a suction grill facing the inner space and forming a passage through which air passes; and
a suction body installed along an outer circumference of the suction grill and extended toward an edge of the discharge guide.

5. The air circulator of claim 4, the discharge guide, comprising:
a core member which is configured to support the motor, and movement of which is constraint;
a guide vane installed along an upper circumference of the core member and configured to guide discharge of air; and
a discharge body installed along an outer circumference of the guide vane and extended toward the suction body.

6. The air circulator of claim 5, wherein a front panel is installed at a front of the core member, and the motor is installed between the core member and the front panel.

7. The air circulator of claim 5, the mixed flow fan, comprising:
a connection body disposed between the core member and the suction grill, connected to an output shaft of the motor, and configured to rotate along with the output shaft;
an inner body extended from the connection body, installed in a way that encircles the core member, and spaced from the core member;
an outer body installed outside the connection body in a ring shape, and spaced from the suction body; and
a wing member configured to connect the inner body and the outer body.

8. The air circulator of claim 5, wherein the discharge guide includes a guide curved surface which protrudes toward an inside of the discharge body, and an inner diameter of which gradually increases from a portion where the discharge guide and the guide vane are connected toward a front of the discharge body from which air is discharged.

9. The air circulator of claim 5, wherein the number of the guide vanes is 65 to 80.

10. The air circulator of claim 5, the guide vane, comprising:
a vane body forming a curved surface where a plate having a trapezoid shape is convexly bent,
wherein a widthwise length of a first end on one end of the vane body is less than a widthwise length of a second end on the other end of the vane body.

11. The air circulator of claim 7, wherein the inner body and the outer body are installed at a slant with respect to the suction grill.

12. The air circulator of claim 7, wherein inner diameters of the inner body and the outer body gradually increase toward the discharge guide.

13. The air circulator of claim 7, the outer body, further comprising:
an inlet projection protruding from the outer body to a rear where the suction grill part is disposed and forming a projection having a ring shape.

14. The air circulator of claim 13, the suction grill part, further comprising:
a bell mouth protruding from the suction body toward the mixed flow fan along an edge of the suction grill, and extended to an inside of the inlet projection.

15. The air circulator of claim 14, wherein a gap between the bell mouth and the inlet projection is less than a gap between the outer body and the suction body.

16. The air circulator of claim 7, wherein the inner body is installed in a concave form toward a direction where the core member is installed.

17. The air circulator of claim 7, wherein the wing member is a rectangular plate, and a plurality of wing members are installed along an outer circumference of the inner body and installed upward at a slant.

18. The air circulator of claim 7, the connection body, comprising:
a hub plate having a circular plate shape;
a shaft coupler disposed at a center of the hub plate in a radial direction thereof, and connected to the motor; and
a first reinforcement projection extended from the shaft coupler radially.
